(19) United States
(12) Patent Application Publication
(10) Pub. No.: US 2011/0102390 A1
(43) Pub. Date: May 5, 2011

(54) DISPLAY DEVICE AND METHOD OF CONTROLLING DISPLAY DEVICE

(75) Inventor: Toshiki Moriwaki, Kanagawa (JP)

(73) Assignee: SONY CORPORATION, Tokyo (JP)

(21) Appl. No.: 12/913,918

(22) Filed: Oct. 28, 2010

(30) Foreign Application Priority Data
Nov. 5, 2009 (JP) 2009-254470

(51) Int. Cl. G09G 5/00

(52) U.S. Cl. 345/207

(57) ABSTRACT

A display device includes a flexible substrate, a display unit that has a plurality of light-emitting elements arranged on the substrate and displays an image according to an image signal, a displacement sensor that is disposed on a front surface or a back surface of the substrate and detects a state of a curve of the substrate, a light-receiving unit that is disposed on a plane of the substrate on which the display unit is disposed and detects the amount of light, and a signal control unit that controls an image signal for displaying the image based on the amount of light when the displacement sensor detects the curve of the substrate.

### BACKGROUND OF THE INVENTION

### 1. Field of the Invention

The present invention relates to a display device and a method of controlling a display device.

In recent years, ensuring reliability of a display element in a display device has become an extremely important challenge. Particularly, ensuring structural and mechanical reliability or reliability relating to display performance is still a crucial matter as has been in the past.

For example, Japanese Unexamined Patent Application Publication No. 2005-173193 discloses a technique in which a situation of an image is determined from data such as image data, that can indicate a display state of a device and lighting of a horizontal scan line is controlled to prevent overcurrent, in order to prevent life degradation of an element due to temperature rise according to current flow amount.

Also, Japanese Unexamined Patent Application Publication No. 2007-240617 describes that control of an optical characteristic such as refractive index is performed using a photodetector as a polarization detecting unit by quantitatively detecting the amount of change in deformation due to minute stress applied to a display device as change in polarization state of incident light.

### SUMMARY OF THE INVENTION

However, the technique described in Japanese Unexamined Patent Application Publication No. 2005-173193 has a problem in that manufacturing cost increases in order to ensure reliability, since various feedback controls are used, i.e., many algorithms are used, for complex control combining both a gate signal and a source signal, control of lighting period, and the like. Also, a complex algorithm control leads to an increase in power consumption of a driver IC, causing a decrease in power performance.

With the technique described in Japanese Unexamined Patent Application Publication No. 2007-240617, detecting a minute refractive index according to deformation is difficult when there is noise due to reflection of external light or light scattering by relatively strong external light from another light source such as, for example, sunlight or fluorescent light in a room.

Particularly, in a display device with flexibility, the display element is placed on a thin flexible board and, if the display device is curved, diffuse reflection occurs on the display screen because the incidence state of external light changes. In this type of display device, diffuse reflection also occurs when emitting light of the display element enters the display screen due to the curve. Therefore, a problem is that the display state of an image varies depending on whether the display device is curved.

Thus, it is desirable to provide a novel and improved display device and a method of controlling a display device that can compensate for the display state of a curved flexible display device.

According to an embodiment of the present invention, there is provided a display device including a flexible substrate, a display unit that has a plurality of light-emitting elements arranged on the substrate and displays an image according to an image signal, a displacement sensor that is disposed on a front surface or a back surface of the substrate and detects a state of a curve of the substrate, and a light-receiving unit that is disposed on a surface of the substrate on which the display unit is disposed and detects the amount of light, a signal control unit that controls an image signal for displaying the image based on the amount of light when the displacement sensor detects the curve of the substrate.

The signal control unit may control contrast or white balance of the image.

The signal control unit may make the contrast of the image applied when the displacement sensor detects the curve of the substrate lower than the contrast applied when the substrate is not curved.

The signal control unit may make the white balance of the image applied when the displacement sensor detects the curve of the substrate identical to the white balance applied when the substrate is not curved.

The signal control unit may suppress diffuse reflection on a front surface of the display unit by reducing an output of the image signal when the displacement sensor detects the curve of the substrate.

The signal control unit may restore an output of the image signal to an original state where the substrate is not curved, when the substrate curved is detected to have returned to a flat state.

The signal control unit may control the image signal based on a lookup table in which a relationship between the amount of light and an output of the image signal is defined.

The light-receiving unit may be disposed in the vicinity of the display unit.

The light-emitting element may include an organic EL light-emitting element and the light-receiving unit may detect the amount of light based on a reverse current generated when the organic EL light-emitting element is illuminated with light.

The displacement sensor may have a pair of transparent electrodes including ITO or IZO and may detect the state of the curve of the substrate based on change in resistance between the pair of transparent electrodes.

According to another embodiment of the present invention, there is provided a method of controlling a display device, including the steps of detecting a state of a curve of a flexible substrate on which a display unit displaying an image according to an image signal is disposed, detecting the amount of light on a surface on which the display unit is disposed, and controlling an image signal for displaying the image based on the amount of light when the curve of the substrate is detected.

In the step of controlling the image signal, the contrast or the white balance of the image may be controlled.

In the step of controlling the image signal, the contrast of the image applied when the curve of the substrate may be lower than the contrast applied when the substrate is not curved.

In the step of controlling the image signal, the white balance of the image applied when the curve of the substrate is detected may be identical to the white balance when the substrate is not curved.

In the step of controlling the image signal, diffuse reflection on a front surface of the display unit may be suppressed by reducing an output of the image signal when the curve of the substrate is detected.

According to the embodiments of the present invention, it is possible to compensate for the display state when the flexible display device is curved.

### BRIEF DESCRIPTION OF THE DRAWINGS

FIG. 1 is a plan view showing a front surface of a display device according to an embodiment of the present invention.

FIG. 2 is a schematic view showing a sectional surface of the display device.

FIG. 3 is a schematic view in which an enlarged light-receiving unit is shown.

FIGS. 4A and 4B are schematic views showing a configuration example of the light-receiving unit in detail.

FIG. 5 is a characteristic diagram showing photoelectric current that generates in an organic EL element when a reverse bias voltage is applied.

FIG. 6 is a schematic diagram showing the scan direction of the light-receiving unit.

FIG. 7 is a schematic diagram showing an example in which a displacement sensor is disposed on a back surface of a display unit.

FIG. 8 is a schematic diagram showing an example in which the displacement sensor is disposed on the back surface of the display unit.

FIG. 9 illustrates a state where the display device is curved, and is a schematic view showing a curved state where the surface on the front side provided with the display unit is a concave surface.

FIG. 10 is a schematic view showing a curved state where the surface provided with the display unit is a convex surface.

FIG. 11 is a block diagram showing the functional configuration of the display device according to the embodiment.

FIG. 12 is a schematic diagram showing a lookup table used to determine an output control value.

FIG. 13 is a schematic diagram showing a lookup table that defines the relationship between a resistance change amount and a diffuse reflection acceptance value.

FIG. 14 is a block diagram showing a configuration example of the display device according to the embodiment.

FIG. 15 is a flowchart showing processing performed by the configuration in FIG. 14.

FIG. 16 is a schematic diagram showing an example of a lookup table (LUT) used for output control in consideration of diffuse reflection.

FIG. 17 illustrates a cross section of the display device, and is a schematic view showing a configuration example in which the displacement sensor is provided to front and back surfaces of the display device.

FIG. 18 is a schematic view showing the state where the display device shown in FIG. 17 is curved.

### DESCRIPTION OF THE PREFERRED EMBODIMENTS

A preferred embodiment of the present invention will be described in detail below with reference to the accompanying drawings. Note that, in this specification and the drawings, components having substantially the same functional configuration are denoted by the same reference numeral to omit redundant description.

Note that descriptions will be given in the following order.

1. Configuration example of display device
2. Function block configuration of display device
3. Adjustment of contrast
4. Adjustment of white balance
5. Adjustment of diffuse reflection
6. Configuration example in which displacement sensors are disposed on the front and back surfaces

### [1. Configuration Example of Display Device]

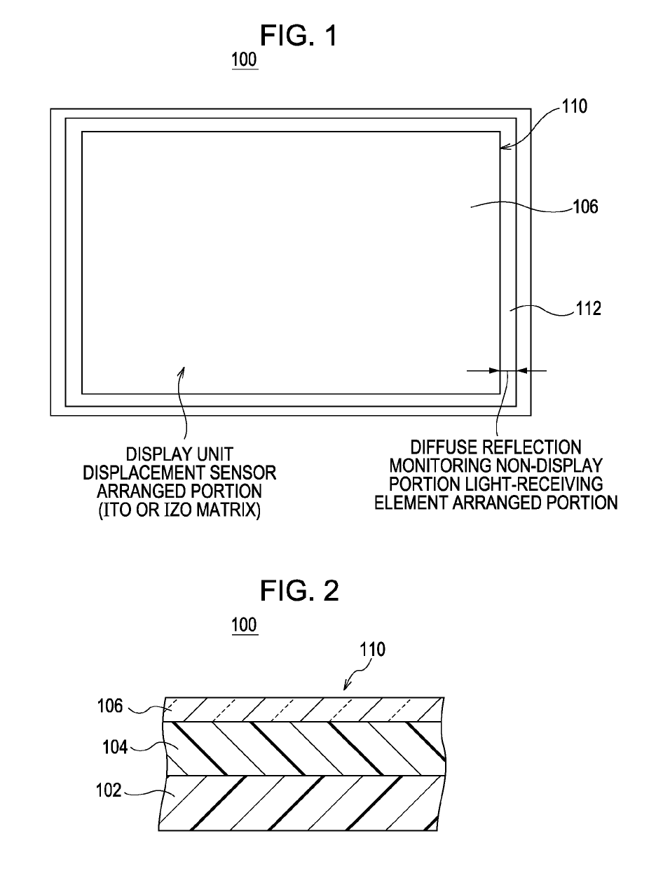

First, with reference to FIGS. 1 and 2, a schematic configuration of a display device 100 according to an embodiment of the present invention will be described. FIG. 1 is a plan view showing a front surface of the display device 100. The display device 100 includes a display unit 110 including a semiconductor layer described later and in which a plurality of pixels are arranged in a matrix. The display unit 110 displays an image such as a still image or a moving image by causing each pixel to emit light according to an image signal.

FIG. 2 is a schematic view showing a cross section of the display device 100. In this embodiment, as shown in FIG. 2, a first substrate 102, a second substrate 104, and a displacement sensor 106 are stacked to form the extremely thin display device 100 having a thickness of approximately several tens of micrometers. The first substrate 102 is configured with a display element (light-emitting element), which is included in each pixel, formed on a flexible substrate, e.g., a plastic substrate formed of resin. As the display element, an organic semiconductor or inorganic semiconductor element that can be formed by a low-temperature process may be used. In this embodiment, an organic EL (electroluminescence) element is formed as the display element in the first substrate 102.

The second substrate 104 is also formed of a plastic substrate formed of resin, is arranged to face the first substrate 102 including the display element formed of an organic semiconductor or an inorganic semiconductor, and has a function as a sealing substrate that seals in the display element. In this manner, the display device 100 is formed by two types of substrates, i.e., the first substrate 102 and the second substrate 104, holding the semiconductor layer in between in this embodiment. The display unit 110 displays an image on a surface on the second substrate 104 side. With such a configuration, the display device 100 is formed with a thickness of approximately several tens of micrometers, has flexibility, and can be curved freely in a state where an image is displayed.

As shown in FIGS. 1 and 2, the displacement sensor 106 formed of a transparent electrode body, e.g., an ITO film or IZO film, is arranged on a surface of the second substrate 104. The displacement sensor 106 is formed, for example, in the same region as the display unit 110. The displacement sensor 106 is formed of the transparent electrode body, and is each arranged to face the display element of the first substrate 102.

The displacement sensor 106 has a configuration similar to, for example, an electrode for an available touch screen. Two metal thin films (resistance films) formed of a transparent electrode of ITO, IZO, or the like are arranged to face each other, and multiple pairs of the metal thin films are arranged, for example, in a matrix in a flat surface region. The facing transparent electrodes of the displacement sensor 106 have resistance. One of the electrodes is applied with predetermined voltage, and a resistance value between the electrodes is monitored. With such a configuration, change in the resistance value can be detected because, when the display device 100 is curved, the resistance value between the two metal thin films changes at a position of a curve and voltage according to the curve is generated at the other electrode. Thus, by detecting the metal thin films for which the resistance value has changed out of the multiple pairs of the metal thin films arranged in the matrix, a position of displacement among the displacement sensors 106 can be detected and a position of bend in the display unit 110 can be detected. The change in the resistance value increases as a bend amount of the display device 100 increases. In this manner, the display device 100 can detect the amount of change in resistance detected by the displacement sensor 106 and detect a bend position and the bend amount of the display device 100.

Also, the display device 100 according to the embodiment includes a light-receiving unit 112 detecting external light or the amount of light generated by diffuse reflection on the surface. As shown in FIG. 1, the light-receiving unit 112 is disposed in the area surrounding the display unit 110.

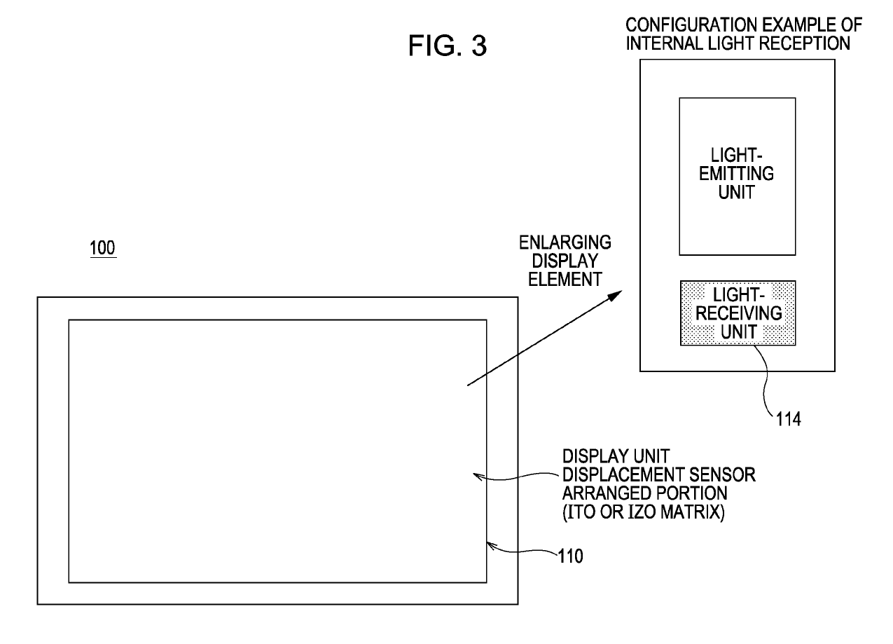

A light-receiving unit 114 is also disposed in each element of the display unit 110. FIG. 3 is a schematic view in which the light-receiving unit 114 is enlarged. As shown in this figure, the light-receiving unit 114 is placed adjacent to each emitting element of the display elements arranged in a matrix in the display unit 110.

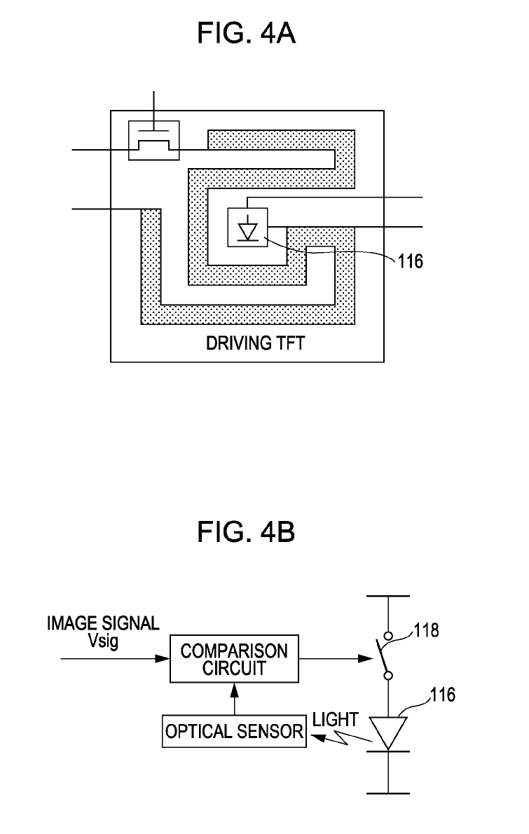

FIGS. 4A and 4B are schematic views showing a configuration example of the light-receiving unit 114 in detail. As shown in FIG. 4A, each pixel of the display unit 110 includes an organic EL element 116. FIG. 4B shows an equivalent circuit including the organic EL element 116. As shown in FIG. 4B, a switch 118 is connected in series to the organic EL element 116 in each pixel. The light-receiving unit 114 in each pixel detects the amount of light with which the display unit 110 is illuminated, by detecting photoelectric current when the organic EL element 116 receives light by applying a reverse bias voltage to the organic EL element 116 with the switch 118 turned on.

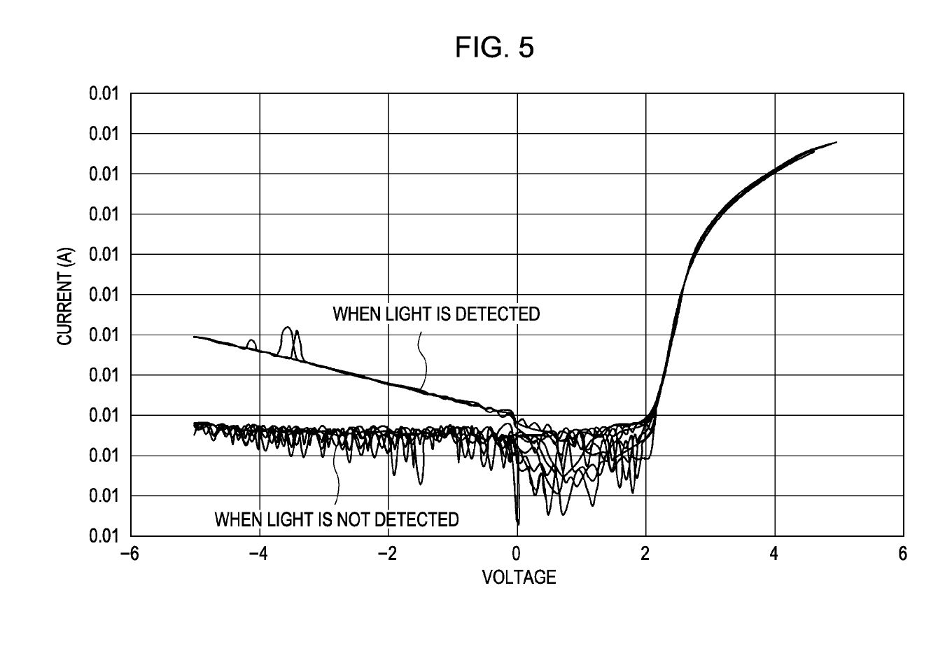

FIG. 5 is a characteristic diagram showing photoelectric current that generates in the organic EL element 116 when a reverse bias voltage is applied. As shown in FIGS. 4A and 4B, when the organic EL element 116 detects light, a photoelectric current generates according to the reverse bias voltage. The light-receiving unit 114 disposed in each pixel compares the value of photoelectric current with the image signal one frame before and detects the amount of external light or diffuse reflection.

As described above, the display device 100 according to the embodiment includes two types of light-receiving units: the light-receiving unit 112 disposed in the area outside the display unit 110 and the light-receiving unit 114 disposed in each pixel of the display unit 110.

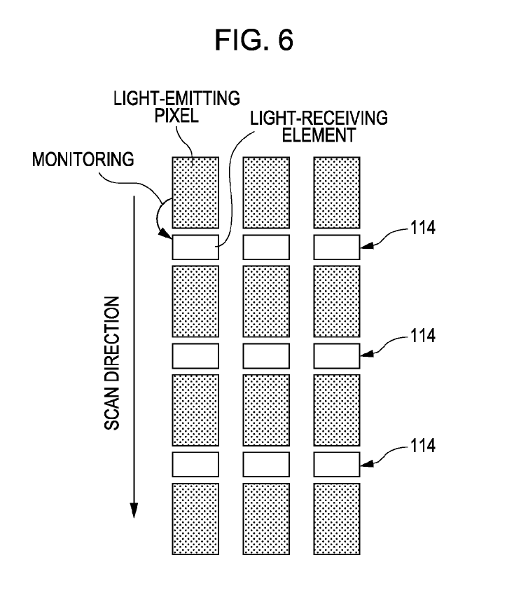

FIG. 6 is a schematic diagram showing the scan direction of the light-receiving unit 114. The light-receiving unit 114 is arranged in a matrix adjacent to each emitting element. As shown in FIG. 6, detection of the amount of light by the light-receiving unit 114 is done in sequence from one end of the screen to the other end. At this time, each of the EL elements 116 detects the amount of light by turning on the switches 118 linearly in sequence.

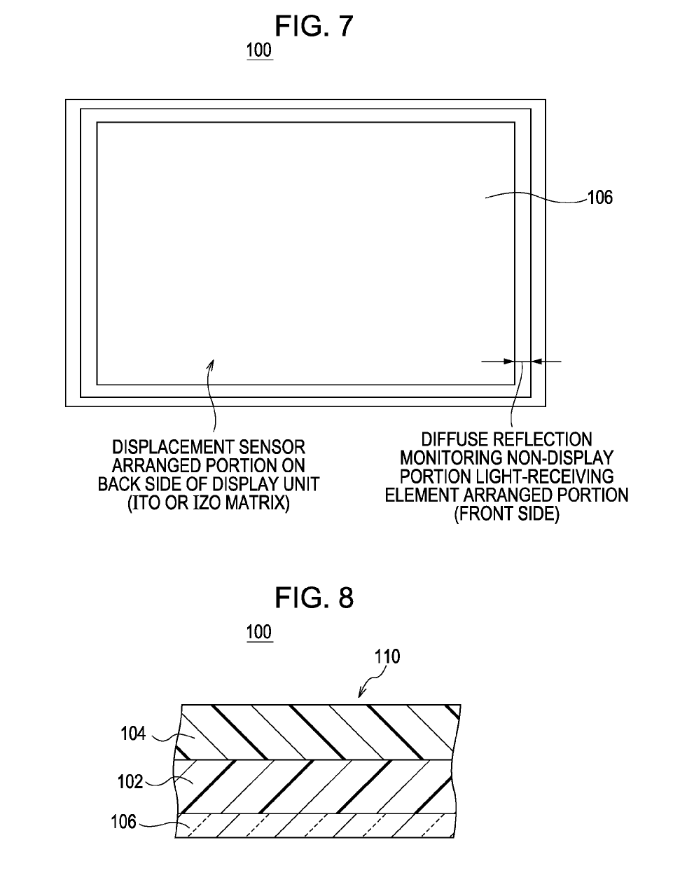

FIGS. 7 and 8 are schematic diagrams showing an example in which the displacement sensor 106 is disposed on the back surfaces of the display unit 110. FIG. 7 is a plan view of the back surface of the display device 100 and FIG. 8 is a cross-sectional view of the display device 100. In FIGS. 7 and 8, the configurations of the first substrate 102 and the second substrate 104 are identical to those of the display device 100 in FIGS. 1 and 2. In this configuration example, as shown in FIG. 8, the displacement sensor 106 is disposed on the back surface of the first substrate 102. Even when the displacement sensor 106 is disposed on the back surface of the display unit 110, the curve amount and the curve position of the display device 100 can be detected according to the change in the resistance value as in the case where it is disposed on the front side. It is assumed that the light-receiving units 112 and 114 are disposed on the front side as in the display device 100 shown in FIGS. 1 and 2.

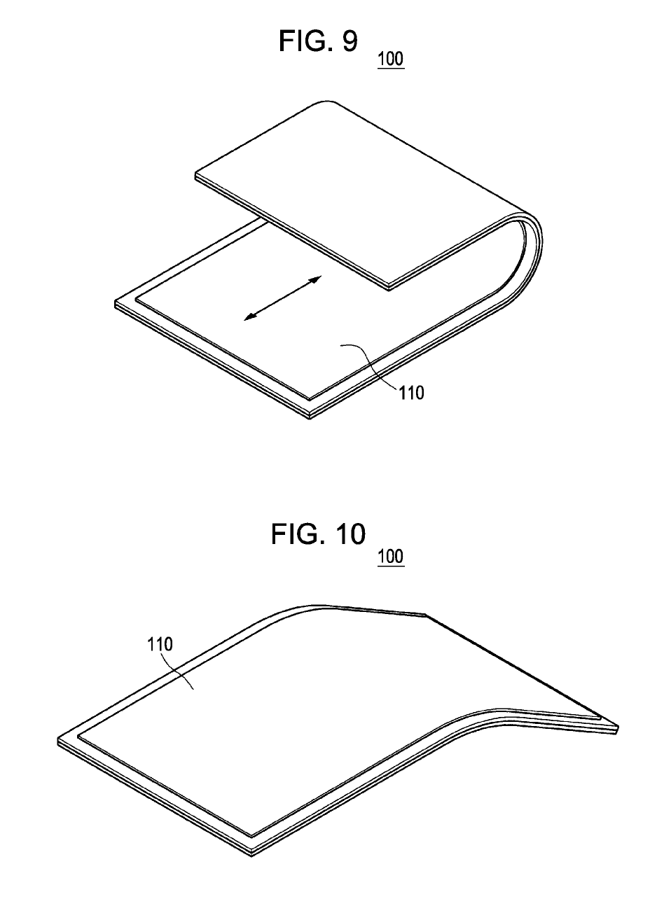

FIG. 9 is a schematic view showing the state where the display device 100 is curved so that the front side surface on which the display unit 110 is disposed is concave. FIG. 10 shows the state where the display device 100 is curved so that the surface on which the display unit 110 is disposed is convex.

As shown in FIGS. 9 and 10, when the display device 100 is curved, the state where external light is incident on the display unit 110 varies depending on the curve and the display state of an image varies depending on the reflection on the surface. Also, in the curved section, diffuse reflection due to external light or diffuse reflection due to light emitted from proximity display elements occurs and the display state of the display unit 110 changes. In addition, the curve changes the reflection ratio on the surface of the display unit 110, thereby changing the display state of the display unit 110.

In this embodiment, in view of the this phenomenon, output to display elements including organic semiconductors or inorganic semiconductors including the first substrate 102 is controlled depending on the detected value of a resistance change amount of the resistance value detected by the displacement sensor 106, and the contrast, white balance, diffuse reflection, and other display states of the image displayed in the display unit 110 are controlled based on the curve time displacement amount (curve amount) of the display unit 110 obtained from the resistance change amount. In this embodiment, this can compensate for change in the display states due to a curve of the display unit 110.

### [2. Function Block Configuration of Display Device]

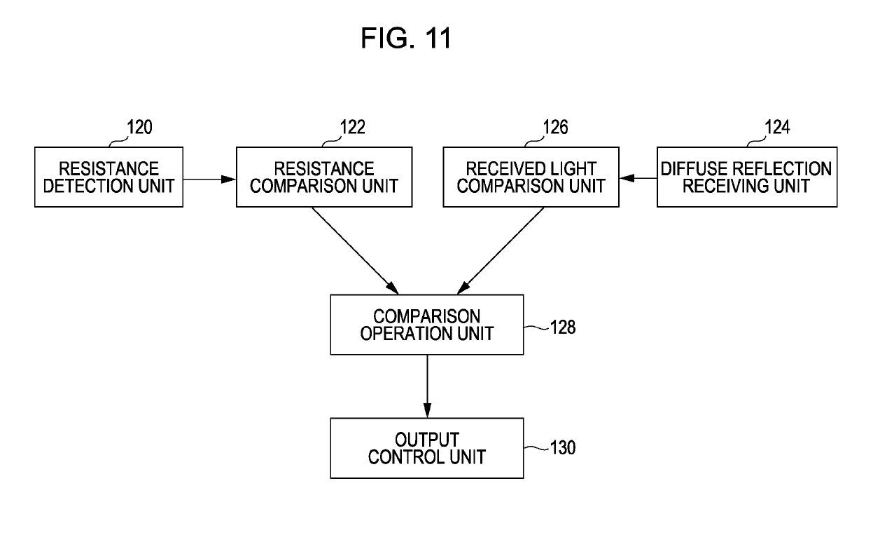

A specific control technique will be described below. FIG. 11 is a block diagram showing the functional configuration of the display device 100 according to this embodiment. A function block shown in FIG. 11 may include hardware such as a sensor or a circuit, or a central processing unit (CPU) with software (program) for enabling a function thereof. As shown in FIG. 11, the display device 100 includes a resistance detection unit 120, a resistance comparison unit 122, a diffuse reflection receiving unit 124, a received light comparison unit 126, a comparison operation unit 128, and an output control unit 130. The resistance detection unit 120 corresponds to the displacement sensor 106 described above, and the resistance detection unit 120 detects the resistance value as an analog value corresponding to the curve amount. The resistance comparison unit 122 detects change in the resistance value detected by the resistance detection unit 120. The resistance comparison unit 122 detects change by comparing the reference resistance when the display device 100 is not curved with the resistance value detected by the resistance detection unit 120.

The diffuse reflection receiving unit 124 corresponds to the above light-receiving units 112 and 114 and detects the amount of light on a surface of the display device 100. The received light comparison unit 126 detects the amount of change in the amount of received light detected by the diffuse reflection receiving unit 124. The received light comparison unit 126 detects change by comparing the reference amount of received light when the display device 100 is not curved with the amount of received light detected by the diffuse reflection receiving unit 124.

When change in the resistance value is detected, the resistance comparison unit 122 outputs the change to the comparison operation unit 128. When change in the resistance value is detected, the resistance comparison unit 122 further inputs the position information of the displacement sensor 106 to the comparison operation unit 128. When no change in the resistance value is detected, that is, there is no difference between the resistance value detected by the resistance detection unit 120 and the reference resistance, then the display device 100 is not curved and no change in the resistance value is output to the comparison operation unit 128.

When the amount of change in the amount of received light is detected, the received light comparison unit 126 outputs the amount of change to the comparison operation unit 128. When the amount of change in the amount of received light is not detected, that is, there is no difference between the amount of received light detected by the diffuse reflection receiving unit 124 and the reference amount of received light, the amount of change is not output to the comparison operation unit 128.

The comparison operation unit 128 determines an output control value of the display unit 110 based on the amount of change that was input. The comparison operation unit 128 inputs the output control value to the output control unit 130. The output control unit 130 controls the output to the display unit 110 based on the output control value.

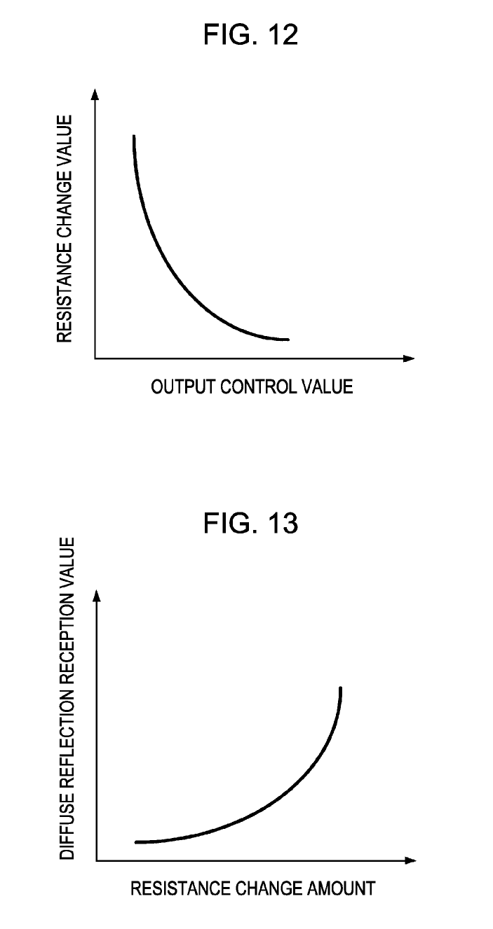

FIG. 12 is a schematic diagram showing a lookup table used to determine the output control value. FIG. 13 is a schematic diagram showing a lookup table in which the relationship between a resistance change value and a diffuse reflection acceptance value is defined. As shown in FIG. 12, the output control value is controlled depending on the change in the resistance of the displacement sensor 106. Accordingly, image display can be controlled depending on the curve of the display unit 110. When the curved display unit 110 becomes flat, the image is also restored to the original state. The comparison operation unit 128 uses these lookup tables to operate the output control value for adjusting the contrast, white balance, and diffuse reflection of an image, depending on the amount of curve and received light.

### [3. Adjustment of Contrast]

Adjustment of contrast will be first described. In the adjustment of contrast, the amount of light received by the light-receiving units 112 and 114 is monitored and a table indicating the correspondence between voltage values output from the light-receiving units 112 and 114 and their brightness values is built into operation circuits in three positions in advance. At the same time, the image output signal is also built into the operation circuit in advance to correspond to voltage input.

Initial values can be set arbitrarily for a correlation expression that defines contrast (ration of high-brightness pixels to low-brightness pixels).

If the amount of change in the voltage detected by the displacement sensor 106 is equal to or more than the threshold (0.2 V is assumed here), the amount of received light detected when the display device 100 is not curved is compared with the amount of received light detected when the display device 100 is curved and the output control unit 130 controls the output of the display unit 110. This is because effects of diffuse reflection on display become greater when the voltage detected by the displacement sensor 106 is equal to or more than 0.2 V. This prevents the display performance from being degraded by improper contrast caused by diffuse reflection. The change amount and output control by the comparison operation unit 128 can be arbitrarily changed by the user.

As shown in FIG. 12, the larger the resistance change value of the displacement sensor 106, the smaller the output control value to be set. This controls the display state so that the display unit 110 with a larger curve has a smaller contrast. Accordingly, it is possible to prevent the screen contrast from being increased and to maintain the proper display state by reducing the contrast as diffuse reflection and external light caused by a curve increase.

Also, as shown in FIG. 13, the larger the resistance change value of the displacement sensor 106, the larger the acceptance value of diffuse reflection; the characteristics are obtained by the display device 100 in advance. Accordingly, the display device 100 makes contrast adjustment, assuming that diffuse reflection occurs when the resistance change value exceeds a threshold. In this case, as described above, contrast adjustment is made if the resistance change value is, for example, 0.2 V or more.

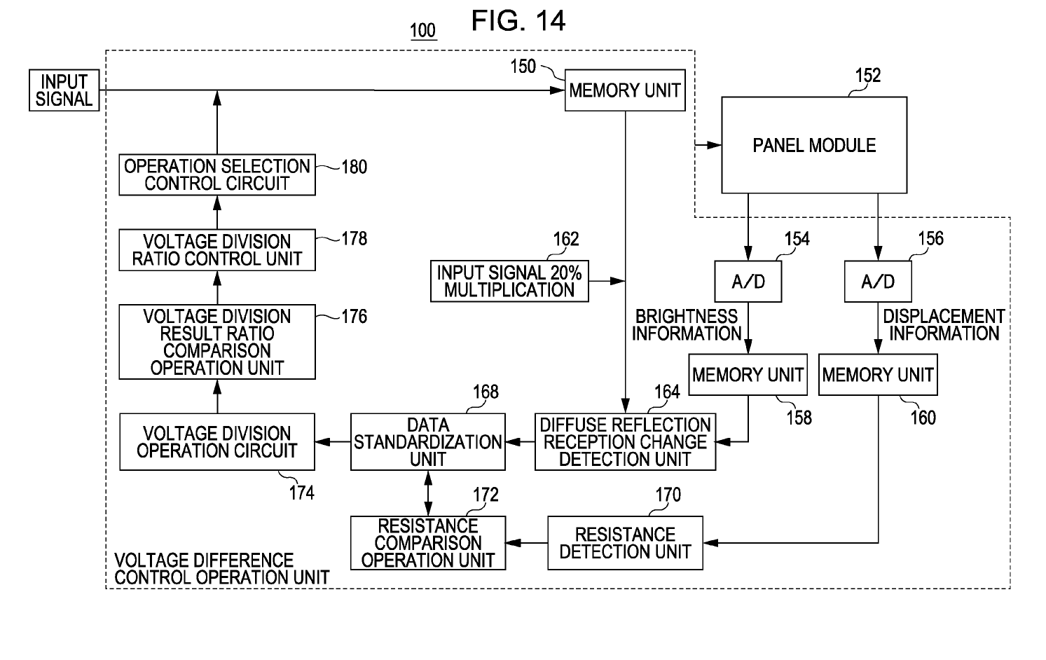

Contrast adjustment will be described in detail below. FIG. 14 is a block diagram showing a configuration example of the display device 100 according to the embodiment. As shown in FIG. 14, the display device 100 includes a memory unit 150, a panel module 152, A/D converters 154 and 156, memory units 158 and 160, a multiplication processing unit 162, a diffuse reflection acceptance change detection unit 164, a data standardization unit 168, a resistance detection unit 170, a resistance comparison operation unit 172, a voltage division operation circuit 174, a voltage division result ratio comparison operation unit 176, a voltage division ratio control unit 178, and an operation selection control circuit 180.

In the configuration shown in FIG. 14, the memory unit 150 temporarily stores a signal to be input to the panel module 152. The panel module 152 is a component of the display unit 110 of the display device 100 and includes organic EL light-emitting elements. The memory unit 158 stores the amount of light detected by the light-receiving units 112 and 114. The memory unit 160 stores the amount of displacement detected by the displacement sensor 106. The multiplication processing unit 162 adds 200 of an image signal stored in the memory unit 150 to the image signal. The diffuse reflection acceptance change detection unit 164 compares an output of the multiplication processing unit 162 with brightness information stored in the memory unit 158 to determine whether any change occurs. The data standardization unit 168 standardizes the amount of change in the amount of received light detected by the diffuse reflection acceptance change detection unit 164.

The voltage division operation circuit 174 divides the detection voltage output from the data standardization unit 168. The voltage division result ratio comparison operation unit 176 determines whether the voltage division result of each pixel is large or not by comparing the voltage division result with the contrast adjustment correlation ratio expression. The voltage division ratio control unit 178 uses the comparison result from the voltage division result ratio comparison operation unit 176 to calculate a value used to manage the output of the pixel to be controlled.

The operation selection control circuit 180 selectively controls the image signal input of a display pixel L1 and a display pixel L2 based on the operation result from the voltage division ratio control unit 178 and compensates for the brightness of the display pixel L1 and the display pixel L2 based on the output.

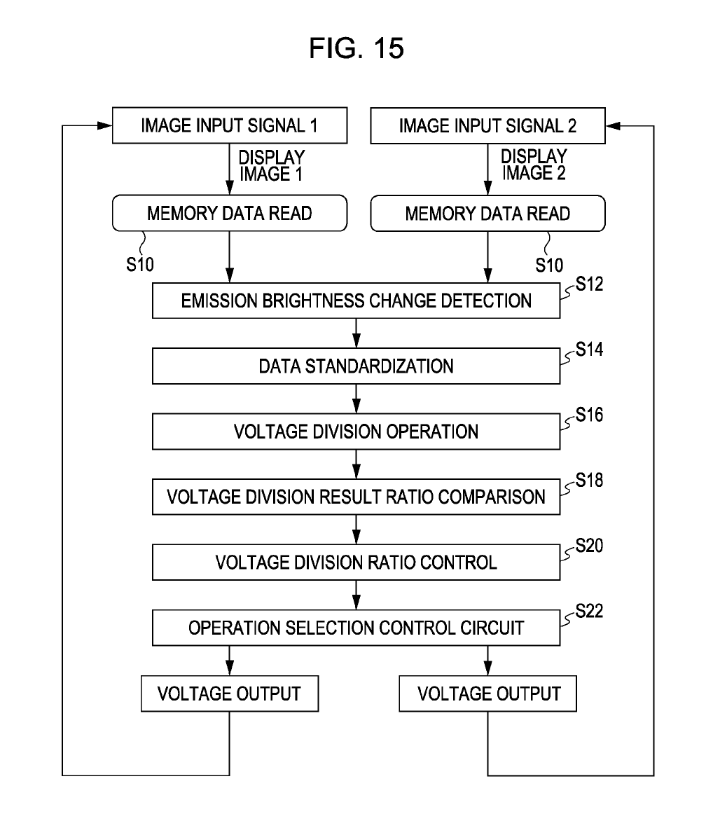

FIG. 15 is a flowchart showing processing performed by the configuration in FIG. 14. First, an initial signal input to the panel module 152 is stored in the memory unit 150 and the signal is read from the memory unit 150 as memory data (step S10). Reading of memory data is performed for the image input signals of a high-brightness pixel L1 and a low-brightness pixel L2. Also, the light-receiving units 112 and 114 monitor the amount of diffuse reflection from the input display pixel of the panel module 152 and the output signal is read as memory data from the memory unit 158. The multiplication processing unit 162 performs 200 multiplication of the memory data of the initial input signal in the memory unit 150 and the multiplied data is input to the diffuse reflection acceptance change detection unit 164 together with data read from the memory unit 158 to detect change in acceptance brightness (step S12).

On the other hand, a resistance value detected by the displacement sensor 106 is A/D converted by the A/D converter 156, stored in the memory unit 160, and then detected by the resistance detection unit 170. The resistance comparison operation unit 172 compares the resistance value detected by the resistance detection unit 170 with the normal value measured when the display device 100 is not curved. As a result of the comparison, when the there is a difference exceeding a predetermined threshold for the normal value, data indicating that the display unit 110 is curved is stored in the memory and the difference is output to the data standardization unit 168.

After step S12, the data standardization unit 168 performs standardization based on the memory data difference between the multiplied initial signal and the monitored amount of diffuse reflection (step S14) and processing is performed as the emission brightness change amounts of display pixels in the display input of high-brightness pixels and low-brightness pixels. The initial brightness values of high-brightness and low-brightness display pixels are assumed to be L1 and L2, respectively.

When the output of the resistance comparison operation unit 172 is equal to or less than a predetermined threshold (0.2 V is assumed here), the display device 100 is assumed to be hardly curved and the data standardization unit 168 does not output the processing result to the voltage division operation circuit 174. On the other hand, when the output of the resistance comparison operation unit 172 is more than the predetermined threshold, the data standardization unit 168 outputs the processing result to the voltage division operation circuit 174 to adjust contrast. Accordingly, in the initial state where the display device 100 is not curved, the processing at stages subsequent to the data standardization unit 168 is not performed.

The following describes an exemplary compensation method applied when, for example, the L1 value becomes 1100 of the initial value in high-brightness display pixels and the L2 value becomes 1050 of the initial value in low-brightness display pixels displayed after a predetermined period of time from the initial state, due to a curve of the display device 100.

In this case, the resistance value detected by the displacement sensor 106 when the display device 100 is curved is stored in the memory and the difference relative to the resistance value detected when the display device 100 is not curved is output to the data standardization unit 168. Next, the diffuse reflection acceptance change detection unit 164 obtains the memory data difference between the multiplied initial signal and the monitored amount of diffuse reflection and the data standardization unit 168 performs the standardization of memory data, so that processing is performed as emission brightness change amounts dL1 and dL2 of display pixels in high-brightness display pixels and low-brightness display pixels.

Next, the voltage division operation circuit 174 performs voltage division operation and performs division calculation of the detected voltage (step S16). In this step, division is made to obtain the ratio of the high-brightness pixel L1 to the low-brightness pixel L2. Next, the voltage division result ratio comparison operation unit 176 compares the voltage division result with the contrast adjustment correlation ratio expression (step S18).

The contrast adjustment correlation ratio expression can be represented by, for example, the following equation. The initial value of R can be set arbitrarily.

High-brightness display brightness L1/low-brightness display brightness L2=R

Next, based on the result of comparison with the contrast adjustment correlation ratio expression, the voltage division ratio control unit 178 calculates a value used to manage the output of the pixel to be controlled (step S20). The operation selection control circuit 180 controls the image signal, compensates for the brightness of high-brightness display pixels and low-brightness display pixels so that the R value measured when the display device 100 is curved changes from the initial R value (step S22). Specifically, the adjustment is made so that the R value measured when the display device 100 is curved becomes smaller than the initial R value. As a result, by application to the image output signal for high-brightness display pixels and low-brightness display pixels, contrast for curve can be suppressed and contrast adjustment can be performed with diffuse reflection due to the curve suppressed.

### [4. Adjustment of White Balance]

Next, adjustment of white balance (WB) will be described below. A functional block for adjustment of white balance is the same as that shown in FIG. 11. In adjustment of white balance, the light-receiving units 112 and 114 are disposed for each of RGB, the amounts of light received by the light-receiving units 112 and 114 are monitored constantly, and the table indicating the correspondence between the voltage values output from the light-receiving units 112 and 114 and their brightness values is built into the operation circuits in the three positions in advance. At the same time, the image output signal is also built into the operation circuit in advance to correspond to voltage input.

The following correlation expression is used to define white balance; the initial values of X, Y, and Z can be set in advance. V_{LR}, V_{LG}, and V_{LB} are output voltage values corresponding to the brightness values of RGB, respectively.

V_{LR}/(V_{LR}+V_{LG}+V_{LB})=X

V_{LG}/(V_{LR}+V_{LG}+V_{LB})=Y

V_{LB}/(V_{LR}+V_{LG}+V_{LB})=Z

If the amount of change in the voltage detected by the displacement sensor 106 is equal to or more than 0.2 V, the amount of received light detected when the display device 100 is not curved is compared with the amount of received light detected when the display device 100 is curved and the output control unit 130 controls the output of the display unit 110. This prevents the display performance from being degraded by improper white balance caused by diffuse reflection. The change amount and output control by the comparison operation unit 128 can be arbitrarily changed by the user.

White balance can also be adjusted by using the same configuration as in FIG. 14 together with the processing indicated by the flowchart shown in FIG. 15. As in adjustment of contrast, in each of display inputs, the processing is performed in response to the amount of change in the emission brightness of a display pixel. Specifically, as in the case of contrast, the X, Y, and Z values in the above expression are calculated in response to the change in brightness. If any of V_{LR}, V_{LG}, and V_{LB} changes, control is made so as to keep white balance constant by changing the other values.

It is assumed that, for example, if the brightness L_{R} of the display pixel L1 increases to 110% of the initial value, it is detected as a voltage value of 4.4 V and, in a display pixel 2, 105% of emission brightness amount is detected as 10.5 V in brightness L_{G}. In this case, the value of each correlation expression is output from the voltage division operation circuit 174. Where, the L_{B} value does not change from the initial value and output as a voltage value of 2.0 V.

Relative comparison with the initial X, Y, Z values is performed in the voltage division result ratio comparison operation unit 176; comparison with the initial setting (¼) is performed at the X value in the display pixel L1; an output reduction limitation of 0.4 V is applied to the brightness L_{R} of the display pixel L1 in the voltage division ratio control unit 178.

Since the brightness L_{G} changes in the display pixel 2, the brightness L_{G} is compared with the initial setting (⅝) at the Y value and, in the voltage division ratio control unit 178, an output limitation of 0.5 V is applied to the brightness L_{G}. Then, the display pixels L1 and L2 are selectively controlled by selection control by the operation selection control circuit 180. As a result, it is possible to perform the adjustment of white balance of the display pixels L1 and L2 in response to effects of diffuse reflection due to a curve.

### [5. Adjustment of Diffuse Reflection]

Next, adjustment of diffuse reflection will be described below. A functional block for adjustment of diffuse reflection is the same as that shown in FIG. 11. It is assumed that, if there is variation equal to or more than the predetermined threshold (0.2 V) in the resistance value of the displacement sensor 106, the display unit 110 is affected by diffuse reflection. In this case, the displacement sensor 106 monitors the resistance value and the comparison operation unit 128 compares the resistance change value with the initial value. When, for example, the comparison operation unit 128 determines that variation in the detection value by the light-receiving units 112 and 114 is 20% or more and variation in the detection voltage by the displacement sensor 106 is 0.2 V or more, the output control unit 130 controls the output in consideration of diffuse reflection. In this case, the display performance is kept by reducing the display output by 15% in order to suppress diffuse reflection to the display unit 110. The value variation and output control in the comparison operation unit 128 can be change arbitrarily by the user.

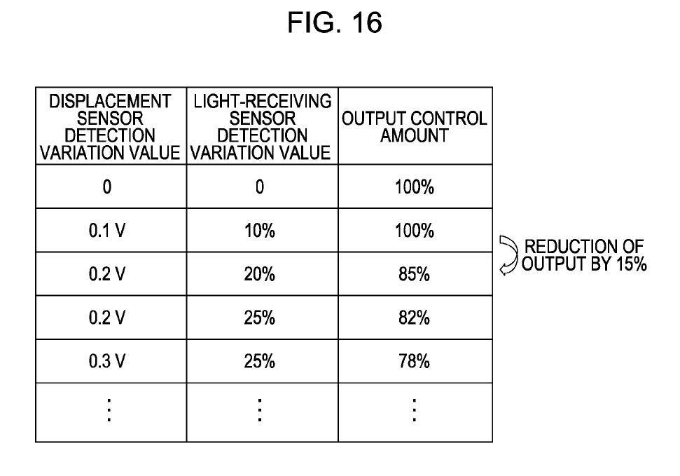

FIG. 16 is a schematic diagram showing an example of a lookup table (LUT) used for output control in consideration of diffuse reflection. As shown in FIG. 16, for the resistance change value of the displacement sensor 106 and the detection variation values of the light-receiving units 112 and 114, the corresponding values are obtained in advance. As shown in FIG. 16, when variation in the resistance value of the displacement sensor 106 is 0.2 V or more and variation in the detection values of the light-receiving units 112 and 114 are 200 or more, output to the display unit 110 is reduced to 85%. This reliably suppresses degradation in visibility of display caused by diffuse reflection in the display unit 110 even when the display device 100 is curved.

[6. Configuration Example in which Displacement Sensors are Disposed on the Front and Back Surfaces]

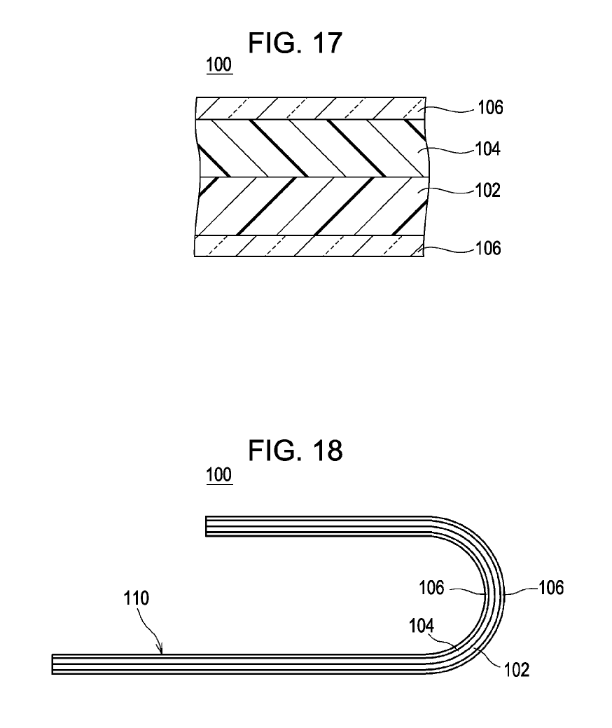

FIG. 17 illustrates a cross section of the display device 100 that has the displacement sensors disposed on the front and back surfaces of the display device 100. FIG. 18 is a schematic view showing the state where the display device 100 shown in FIG. 17 is curved. In the curved portion in FIG. 18, the curvature radius of the displacement sensor 106 on the back surface on which the display unit 110 is not disposed is larger than the curvature radius of the displacement sensor 106 on the front surface on which the display unit 110 is disposed. More specifically, the curvature radius of the displacement sensor 106 on the back surface is larger by the thicknesses of the first substrate 102 and the second substrate 104. Accordingly, the curve amount of the displacement sensor 106 on the front surface is larger than that of the displacement sensor 106 on the back surface, and the resistance change amount of the displacement sensor 106 on the front surface, which has a larger curve amount, is larger than that of the displacement sensor 106 on the back surface.

According to the configuration shown in FIG. 17, if the resistance change amounts are detected by the displacement sensors 106 on the front and back surfaces and the resistance change amounts on both surfaces are mutually compared, it is possible to detect which of the front and back surfaces is a convex surface or concave surface. Accordingly, the output control unit 130 switches control types depending on whether the front surface of the display unit 110 is concave or convex. For example, when the front surface of the display unit 110 is concave, diffuse reflection increases due to emission of the display element, so control can be made so that the signal output value is reduced, as compared with the case where the display unit 110 is convex.

The present application contains subject matter related to that disclosed in Japanese Priority Patent Application JP 2009-254470 filed in the Japan Patent Office on Nov. 5, 2009, the entire content of which is hereby incorporated by reference.

The embodiment of the present invention has been described in detail above with reference to the drawings, but the present invention is not limited to the embodiment. It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a flexible substrate;
a display unit that has a plurality of light-emitting elements arranged on the substrate and displays an image according to an image signal;
a displacement sensor that is disposed on a front surface or a back surface of the substrate and detects a state of a curve of the substrate;
a light-receiving unit that is disposed on a surface of the substrate on which the display unit is disposed and detects an amount of light; and
a signal control unit that controls an image signal for displaying the image based on the amount of light when the displacement sensor detects the curve of the substrate.

2. The display device according to claim 1, wherein the signal control unit controls contrast or white balance of the image.

3. The display device according to claim 2, wherein the signal control unit makes the contrast of the image applied when the displacement sensor detects the curve of the substrate lower than the contrast applied when the substrate is not curved.

4. The display device according to claim 2, wherein the signal control unit makes the white balance of the image applied when the displacement sensor detects the curve of the substrate identical to the white balance applied when the substrate is not curved.

5. The display device according to claim 1, wherein signal control unit suppresses diffuse reflection on a front surface of the display unit by reducing an output of the image signal when the displacement sensor detects the curve of the substrate.

6. The display device according to claim 1, wherein the signal control unit restores an output of the image signal to an original state where the substrate is not curved, when the substrate curved is detected to have returned to a flat state.

7. The display device according to claim 1, wherein the signal control unit controls the image signal based on a lookup table in which a relationship between the amount of light and an output of the image signal is defined.

8. The display device according to claim 1, wherein the light-receiving unit is disposed in the vicinity of the display unit.

9. The display device according to claim 1, wherein the light-emitting element includes an organic EL light-emitting element and the light-receiving unit detects the amount of light based on a reverse current generated when the organic EL light-emitting element is illuminated with light.

10. The display device according to claim 1, wherein the displacement sensor has a pair of transparent electrodes including ITO or IZO and detects the state of the curve of the substrate based on change in resistance between the pair of transparent electrodes.

11. A method of controlling a display device, comprising the steps of:
detecting a state of a curve of a flexible substrate on which a display unit displaying an image according to an image signal is disposed;
detecting an amount of light on a surface on which the display unit is disposed, and;
controlling an image signal for displaying the image based on the amount of light when the curve of the substrate is detected.

12. The method of controlling a display device according to claim 11, wherein, in the step of controlling the image signal, contrast or white balance of the image is controlled.

13. The method of controlling a display device according to claim 12, wherein the contrast of the image applied when the curve of the substrate is detected is made lower than the contrast applied when the substrate is not curved.

14. The method of controlling a display device according to claim 12, wherein the white balance of the image applied when the curve of the substrate is detected is made identical to the white balance when the substrate is not curved.

15. The method of controlling a display device according to claim 11, wherein diffuse reflection on a front surface of the display unit is suppressed by reducing an output of the image signal when the curve of the substrate is detected.
